(19) United States
(12) Patent Application Publication
(10) Pub. No.: US 2023/0294203 A1
(43) Pub. Date: Sep. 21, 2023

(54) ONE-DIMENSIONAL OPTICAL LATTICE PRODUCTION DEVICE AND METHOD WITH CALIBRATION FUNCTION

(71) Applicant: Shanxi University, Taiyuan City (CN)

(72) Inventors: Jizhou WU, Taiyuan City (CN); Jun JIAN, Taiyuan City (CN); Wenliang LIU, Taiyuan City (CN); Yuqing LI, Taiyuan City (CN); Jie MA, Taiyuan City (CN)

(21) Appl. No.: 17/860,899

(22) Filed: Jul. 8, 2022

(30) Foreign Application Priority Data
Mar. 17, 2022 (CN) 202210263967.3

(51) Int. Cl. B23K 26/06; G21K 1/00; G21K 1/093; G21K 1/16

(52) U.S. Cl. CPC B23K 26/0665; G21K 1/006; G21K 1/093; G21K 1/16; B23K 26/0643; B23K 26/0648; G02B 6/1225

(57) ABSTRACT

The production device includes a laser incident unit, a scientific chamber, a reflection unit, and a light path coincidence calibration unit detachably arranged. The light path coincidence calibration unit includes: a fourth polarizing beam splitter, a fourth half-wave plate and a fifth half-wave plate sequentially arranged on a laser path of the laser incident unit; and an optical power probe arranged on the reflection path of the fourth polarizing beam splitter. The fourth half-wave plate and the fifth half-wave plate are adjusted so that the light is reflected when passing through the fourth polarizing beam splitter. The optical power probe can receive the reflected light, the angle of the reflected light can be changed by adjusting the reflection unit; the angle change of the reflected light may directly influence the intensity of the reflected light received by the optical power probe.

### CROSS REFERENCE TO RELATED APPLICATION

This patent application claims the benefit and priority of Chinese Patent Application No. 202210263967.3 filed on Mar. 17, 2022, the disclosure of which is incorporated by reference herein in its entirety as part of the present application.

### TECHNICAL FIELD

The present disclosure relates to the field of optical lattice production equipment, and particularly to a one-dimensional optical lattice production device and method with calibration function.

### BACKGROUND ART

With generation of laser, the method of using laser to decelerate atoms has greatly promoted development of the field of ultra-cold atoms; furthermore, science researches' knowledge about ultra-cold atoms becomes deeper due to realization of Bose-Einstein Condensation (BEC). Description of the ultra-cold atomic system is realized by constructing Hamiltonian of the ultra-cold atomic system. Similar to other systems, the Hamiltonian of the ultra-cold atom includes a kinetic energy term, a potential energy term and an interaction term. Among them, for the potential energy term in the Hamiltonian, optical lattice technology can provide a perfect periodic external potential for the ultra-cold atom, and interaction of atoms in the lattice can be enhanced by regulating the periodic external potential, so that the research of the ultra-cold atoms goes into a field of strong correlation; furthermore, because the optical lattice system is pure and free of impurities, it is also one of the important means to realize quantum simulation of the solid-state lattice model and large-scale quantum information processing by ultra-cold atoms.

As early as the 1970s, the idea of using laser to construct lattice potential field in atomic gas was proposed. Before ultra-cold atom BEC, optical lattices were used in laser-cooled cold atom experiments, in which motion of a single atom in a periodic potential was mainly studied. However, in the temperature range of the cold atom field (T>1 mK), the temperature of the atom in the system is relatively high, which not only leads to a low filling rate of the atom in the lattice, but the interaction effect among atoms cannot be observed effectively due to thermal motion of the atoms, thereby preventing further application of optical lattices. With development of experimental technology, the study of cold atoms has entered the ultra-cold field (T<1 mK), the temperature of the atom in the system can be greatly reduced, the limitation caused by the high atomic temperature above is broken, and the optical lattice has become an important technology for the study of strongly correlated systems.

Based on the experimental system for realizing BEC, the optical lattice can be realized by forming a periodic standing wave field through coherent interference of a laser beam propagating back and forth. From a theoretical point of view, the experimental light path is to add one additional lens and one reflector behind the light path of the lattice light to return the light the same path, and refocuses it on the atomic group. Although the light path is simple, the beam waist radius of the generally used laser beam is only in the order of 10 microns. It is very difficult to realize that, the two round-trip beams are exactly the same, and coincide with each other and interfere well at the atomic group to form a stable standing wave field. Furthermore, measuring degree of coincidence of incident light and reflected light is so difficult that it is impossible to efficiently calibrate the coincident light path.

For example, the Chinese application No. 201310154298.7, titled “A device for producing a one-dimensional monochromatic dislocation rubidium strontium optical lattice”, and the Chinese application No. 202110612206.X, titled “Adjustable vortex array production method and device based on optical induction atomic lattice”, disclose the production device of one-dimensional optical lattice, but they only describe preparation of optical lattice by using coincidence of incident light and reflected light; the disclosed production device has no calibration function, which easily causes the problem that reflected light has a large offset, and reduces the quality of the light lattice.

Therefore, there is an urgent need for a one-dimensional optical lattice production device with calibration function that can improve quality of the optical lattice.

### SUMMARY

An object of the present disclosure is to provide a one-dimensional optical lattice production device and method with calibration function so as to solve the problems existing in the above-mentioned prior art, which is provided with a light path coincidence calibration unit so that coincidence degree of incident light and reflected light in a scientific chamber is improved, thereby improving quality of a one-dimensional optical lattice.

In order to achieve the above object, the present disclosure provides the following solutions. A one-dimensional optical lattice production device with calibration function includes a laser incident unit, a scientific chamber for forming an optical lattice, a reflection unit for reflecting laser, and a light path coincidence calibration unit that is detachably arranged. Two ends of the scientific chamber are provided with a light inlet and a light outlet respectively, a laser path of the laser incident unit is arranged corresponding to the light inlet, and a reflected laser path of the reflection unit is arranged corresponding to the light outlet. The light path coincidence calibration unit includes a fourth polarizing beam splitter, a fifth half-wave plate that adjusts reflected laser so that the reflected laser is reflected on the fourth polarizing beam splitter, and a fourth half-wave plate that adjusts incident laser so that the incident laser normally passes through the fourth polarizing beam splitter and the fifth half-wave plate, and an optical power probe. The fourth half-wave plate, the fourth polarizing beam splitter, and the fifth half-wave plate are sequentially arranged on the laser path of the laser incident unit, the optical power probe is arranged on a reflecting path of the fourth polarizing beam splitter.

In some embodiments, the laser incident unit includes a laser transmitter for emitting laser, and an optical fiber coupler, an optical fiber and a collimator connected in sequence; a receiving end of the optical fiber coupler is arranged corresponding to a laser light path of the laser transmitter, and a transmitting end of the collimator is arranged corresponding to the light inlet.

In some embodiments, a first half-wave plate and a first polarizing beam splitter are arranged on a laser light path between the laser transmitter and the optical fiber coupler; the first half-wave plate is arranged close to the laser transmitter, a second half-wave plate and a second polarizing beam splitter are arranged on a laser light path between the collimator and the light inlet, and the second half-wave plate is arranged close to the collimator.

In some embodiments, a first garbage pool for receiving transmitted light is provided on a transmitted light path of the first polarizing beam splitter, and a second garbage pool for receiving reflected light is arranged on a reflected light path of the second polarizing beam splitter.

In some embodiments, a first lens group, a first reflector, an acousto-optic modulator, a second lens group, a second reflector, and a third reflector are arranged between the first polarizing beam splitter and the optical fiber coupler in sequence. The first lens group is arranged on a reflected light path of the first polarizing beam splitter, and the first reflector reflects transmitted light from the first lens group to the acousto-optic modulator, the second lens group is arranged on a +1 order light path of the acousto-optic modulator, and transmitted light from the second lens group enters the optical fiber coupler after being reflected by the second reflector and the third reflector; and the fourth half-wave plate, the fourth polarizing beam splitter and the fifth half-wave plate are sequentially arranged on a laser path between the second lens group and the second reflector.

In some embodiments, a D-shaped reflector is arranged on a zero-order light path of the acousto-optic modulator, and a third garbage pool for receiving reflected light is arranged on a reflected light path of the D-shaped reflector.

In some embodiments, an optical isolator is arranged between the laser transmitter and the first half-wave plate.

In some embodiments, the reflection unit includes a third polarizing beam splitter, a third half-wave plate and a fourth reflector. A receiving end of the third polarizing beam splitter is arranged corresponding to the light outlet, and the third half-wave plate is arranged on a reflected light path of the third polarizing beam splitter.

In some embodiments, a fourth garbage pool for receiving transmitted light is arranged on a transmitted light path of the third polarizing beam splitter.

It is also provided a production method for a one-dimensional optical lattice production device with calibration function, including following steps:
loading step, configured for loading a magneto-optical trap in a scientific chamber with a vacuum degree of 2.1×10−9 Pa, obtaining an ultra-cold sodium atomic sample in the magneto-optical trap, cooling the ultra-cold sodium atomic sample by compressing the magneto-optical trap and optical molasses, and loading the atomic sample into the optical dipole trap to form sodium BEC in the scientific chamber by evaporative cooling;
propagating step, configured for passing a laser beam through an optical isolator, through a first half-wave plate to a first polarizing beam splitter, entering a transmitted beam of the laser beam into a center of a first garbage pool, passing a reflected beam of the laser beam through a center of a first lens group and into an acousto-optic modulator after being reflected by a first reflector, guiding zero-order light of the acousto-optic modulator into a center of a third garbage pool through a D-shaped reflector, and passing +1 order light of the acousto-optic modulator into an optical fiber coupler through a second lens group, a third reflector, and a fourth reflector; transmitting the laser light through optical fiber, out of a collimator, and into a second polarizing beam splitter; guiding a reflected beam therefrom into a second garbage pool, passing a transmitted beam from the second polarizing beam splitter through a center of the scientific chamber, through a third polarizing beam splitter, and guiding a transmitted beam from the third polarizing beam splitter into a fourth garbage pool and passing the reflected beam therefrom through a third half-wave plate and into a fourth reflector;
adjusting step, configured for adjusting the fourth reflector such that reflected light and incident light roughly coincide, and adjusting the fourth reflector and the collimator upon observing light spots on windows at both sides of the scientific chamber such that the light spots at both sides roughly coincide;
calibrating step, configured for installing a light path coincidence calibration unit, adjusting a fourth half-wave plate and a fifth half-wave plate such that incident light and reflected light enter an optical power probe after being reflected by a fourth polarizing beam splitter, continuously adjusting a fourth reflector upon observing intensity changes of optical power of the optical power probe, removing the light path coincidence calibration unit when a light intensity reach a maximum, thereby completing calibration; and
producing step, configured for producing the one-dimensional optical lattice.

The present disclosure has achieved the following technical effects with respect to the prior art:

1. In the present disclosure, through arrangement of the detachable light path coincidence calibration unit, when it is necessary to adjust the coincidence degree of the incident light and the reflected light, only the light path coincidence calibration unit is installed and the fourth half-wave plate and the fifth half-wave plate are adjusted so that the incident laser light can normally pass through the fourth polarizing beam splitter and the fifth half-wave plate when the reflected light passes through the fourth polarizing beam splitter and is reflected; at this time, the optical power probe can receive the reflected light and obtain the intensity of the reflected light, and then an angle of the reflected light is changed by adjusting the reflection unit, and the change of the angle of the reflected light can directly affect the intensity of the reflected light received by the optical power probe, and then the degree of coincidence between the incident light and the reflected light can be determined by determining the light intensity received by the optical power probe. When the light intensity detected by the optical power probe is the strongest, the coincidence degree between the incident light and the reflected light is the highest.

2. In the present disclosure, the light path coincidence calibration unit can be detachably arranged on a laser path between the second lens group and the second reflector, which ensures that the reflected light whose angle needs to be adjusted does not pass through the structure that can shift the light path, such as the lens group and the acousto-optic modulator, and further ensures that the reflected light propagates in a predetermined direction, so that the detection accuracy of the optical power probe can be ensured. When the reflected light first passes through the optical fiber, the reflected light needs to be first irradiated on the collimator, during adjusting the irradiation, there will be a certain role of auxiliary calibration. Only when the reflected light is irradiated on the collimator, the optical power probe can receive the reflected light with certain intensity. When the reflected light fails to be irradiated on the collimator, the optical power probe may not receive the reflected light, and the light intensity measured by the optical power probe may be decreased significantly. An operator can be reminded correspondingly that adjusting the angle of the reflected light of the reflection unit within a smaller range is beneficial to improve the calibration efficiency.

### BRIEF DESCRIPTION OF THE DRAWINGS

In order to more clearly illustrate the embodiments of the present disclosure or the technical solutions in the prior art, the accompanying drawings used in the embodiments will be briefly described below. Apparently, the drawings in the following description are only some of the present disclosure. For those of ordinary skill in the art, other drawings can also be obtained according to these drawings without paying creative efforts.

FIG. 1 is a schematic structural diagram of a one-dimensional optical lattice production device without a light path coincidence calibration unit, according to the present disclosure;

FIG. 2 is a schematic structural diagram of the one-dimensional optical lattice production device with the light path coincidence calibration unit, according to the present disclosure;

Reference numerals: 1 laser; 2 optical isolator; 3 first half-wave plate; 4 first polarizing beam splitter; 5 first garbage pool; 6 first lens group; 7 first reflector; 8 acousto-optic modulator; 9 D-shaped reflector; 10 third garbage pool; 11 second lens group; 12 second reflector; 13 third reflector; 14 optical fiber coupler; 15 optical fiber; 16 collimator; 17 second half-wave plate; 18 second polarizing beam splitter; 19 second garbage pool; 20 scientific chamber; 21 third polarizing beam splitter; 22 fourth garbage pool; 23 third half-wave plate; 24 fourth reflector; 25 fourth polarizing beam splitter; 26 fourth half-wave plate; 27 fifth half-wave plate; 28 optical power probe; 29 first dipole light; 30 second dipole light

### DETAILED DESCRIPTION OF THE EMBODIMENTS

The technical solutions in the embodiments of the present disclosure will be clearly and completely described below with reference to the accompanying drawings in the embodiments of the present disclosure. Apparently, the described embodiments are only a part of the embodiments of the present disclosure, but not all of the embodiments. Based on the embodiments of the present disclosure, all other embodiments obtained by those of ordinary skill in the art without paying creative efforts shall fall within the protection scope of the present disclosure.

In the description of the present disclosure, the terms “a” or “an” as used herein, are defined as one or more than one; it is to be understood that the terminology used herein is only for the purpose of describing particular embodiments and is not intended to be limiting.

An object of the present disclosure is to provide a one-dimensional optical lattice production device with calibration function to solve the problems existing in the prior art, which is provided with the light path coincidence calibration unit so that coincidence of the incident light and the reflected light in the scientific chamber is improved, thereby improving the quality of the one-dimensional optical lattice.

In order to make the above objects, features and advantages of the present disclosure more clearly understood, the present disclosure will be described in further detail below with reference to the accompanying drawings and specific embodiments.

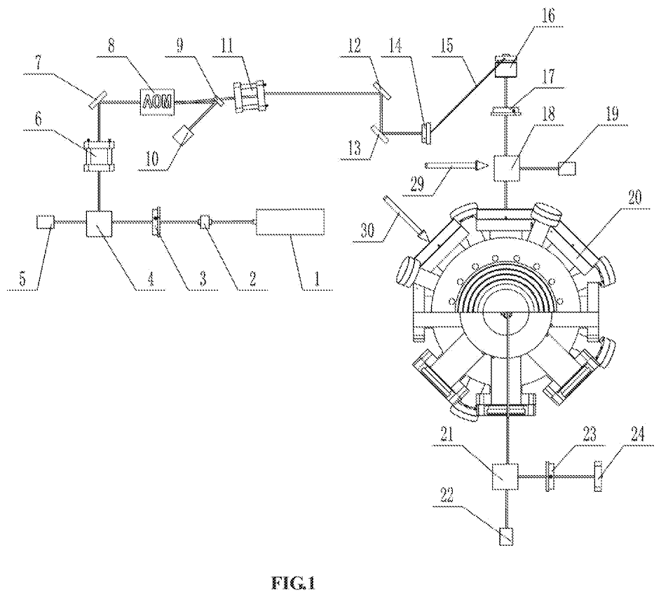

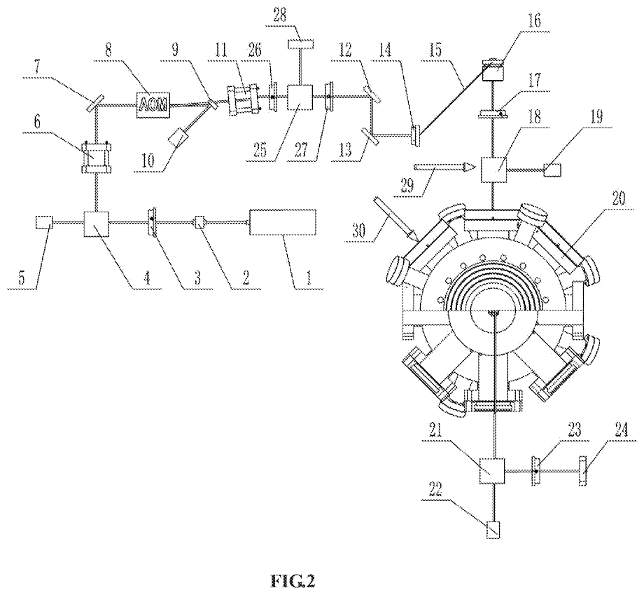

Referring to FIGS. 1 and 2, a one-dimensional optical lattice production device and method with calibration function are provided. The production device includes a laser incident unit, a scientific chamber 20 for forming an optical lattice, a reflection unit for reflecting laser light, and a light path coincidence calibration unit that can be arranged detachably. The specific arrangement is described below. An insertion port is provided in a platform, and the light path coincidence calibration unit is inserted in the insertion port. Two ends of the scientific chamber 20 are respectively provided with a light inlet and a light outlet, a laser path of the laser incident unit is arranged corresponding to the light inlet, and a reflected laser path of the reflection unit is arranged corresponding to the light outlet. The light path coincidence calibration unit includes a fourth polarizing beam splitter 25, a fifth half-wave plate 27 which adjusts the reflected laser so that the reflected laser can reflect on the fourth polarizing beam splitter 25, a fourth half-wave plate 26 which adjusts the incident laser so that the incident laser can normally pass through the fourth polarizing beam splitter 25 and the fifth half-wave plate 27, and an optical power probe 28. The fourth half-wave plate 26, the fourth polarizing beam splitter 25 and the fifth half-wave plate 27 are sequentially arranged on the laser path of the laser incident unit, and the optical power probe 28 is arranged on the reflection path of the fourth polarizing beam splitter 25. In view of detachable arrangement of the light path coincidence calibration unit, when it is desired to adjust the coincidence degree of the incident light and the reflected light, only light path coincidence calibration unit is installed, to adjust the fourth half-wave plate 26 and the fifth half-wave plate 27 so that the incident laser can normally pass through the fourth polarizing beam splitter 25 and the fifth half-wave plate 27, while the reflected light is reflected by the fourth polarizing beam splitter 25. At this time, the optical power probe 28 can receive the reflected light and obtain the intensity of the reflected light, and then an angle of the reflected light is changed by adjusting the reflection unit, and the change of the angle of the reflected light can directly affect the intensity of the reflected light received by the optical power probe 28, and then the degree of coincidence between the incident light and the reflected light can be determined by determining the intensity of the light received by the optical power probe 28. When the light intensity detected by the optical power probe 28 is the strongest, the coincidence degree between the incident light and the reflected light is the highest, and the quality of the generated one-dimensional light lattice can be greatly improved.

The laser incident unit includes a laser transmitter for emitting laser light, an optical fiber coupler 14, an optical fiber 15 and a collimator 16 connected in sequence. A receiving end of the optical fiber coupler 14 is arranged corresponding to the laser light path of the laser transmitter. A transmitting end of the collimator 16 is arranged corresponding to the light inlet. The optical fiber coupler 14 receives the laser and transmits the optical signal to the collimator 16 through the optical fiber 15. The collimator 16 projects the laser into the scientific chamber 20 through the light inlet. The arrangement of the optical fiber coupler 14, the optical fiber 15 and the collimator 16 allows to adjust the angle of the incident light more conventionally by just adjusting the position of the collimator 16, without adjusting the transmitting angle of the laser transmitter.

A first half-wave plate 3 and a first polarizing beam splitter 4 are arranged on the laser light path between the laser transmitter and the optical fiber coupler 14, and the first half-wave plate 3 is arranged close to the laser transmitter. By adjusting the first half-wave plate 3 and in combination with the first polarizing beam splitter 4, polarization and light intensity can be adjusted. A second half-wave plate 17 and a second polarizing beam splitter 18 are arranged on the laser light path between the collimator 16 and the light inlet. The second half-wave plate 17 is disposed close to the collimator 16. By adjusting the second half-wave plate 17 and in combination with the second polarizing beam splitter 18, the polarization and light intensity can be adjusted. By means of combination of two groups of the half-wave plate and the polarizing beam splitter, the polarization and light intensity of the light path entering the scientific chamber 20 can be flexibly adjusted, to meet the requirements for producing the one-dimensional light lattice.

A first garbage pool 5 for receiving transmitted light is provided on the transmitted light path of the first polarizing beam splitter 4, and a second garbage pool 19 for receiving reflected light is provided on the reflected light path of the second polarizing beam splitter 18. The first garbage pool 5 and a second garbage pool 19 are used for collecting unwanted light.

A first lens group 6, a first reflector 7, an acousto-optic modulator 8, a second lens group 11, a second reflector 12 and a third reflector 13 are arranged between the first polarizing beam splitter 4 and the optical fiber coupler 14 in sequence. The first lens group 6 is arranged on the reflected light path of the first polarizing beam splitter 4, and functions to make the waist spot of the light beam thinner to improve the effect of the acousto-optic modulator 8. The first reflector 7 reflects the transmitted light of the first lens group 6 to the acousto-optic modulator 8. The acousto-optic modulator 8 has a function generator to provide frequency information, and operates at the operating frequency of 110 MHz. The second lens group 11 is arranged on a +1 order light path) and functions to make the waist spot of the light beam thinner to improve the efficiency of the optical fiber coupler 14. The transmitted light of the second lens group 11 enters the optical fiber coupler 14 after being reflected by the second reflector 12 and the third reflector 13. The fourth half-wave plate 26, the fourth polarizing beam splitter 25 and the fifth half-wave plate 27 are sequentially arranged on the laser path between the second lens group 11 and the second reflector 12, to allow the reflected light whose angle needs to be adjusted not pass through the lens group, the acousto-optic modulator 8 and other structure which may shift the light path, and in turn the reflected light to propagate in a predetermined direction, thereby ensuring the detection accuracy of the optical power probe 28. When the reflected light passes through the optical fiber 15, the reflected light needs to be first irradiated on the collimator 16, which plays a role of auxiliary calibration to some extent, during adjusting the irradiation. Only when the reflected light is irradiated on the collimator 16, the optical power probe 28 can receive the reflected light with a certain intensity; and when the reflected light fails to be irradiated on the collimator 16, the optical power probe 28 may not receive the reflected light, and the light intensity measured by the optical power probe 28 may be decreased significantly, which may remind an operator to adjust the angle of the reflected light of the reflection unit within a smaller range, to improve the calibration efficiency.

The first lens group 6 and the second lens group 11 each include one convex lens and one concave lens, and the convex lens is arranged close to the incident end.

Since the zero-order light of the acousto-optic modulator 8 is not used, a spacing between the zero-order light and the +1 order light is small, a D-shaped reflector 9 for light separation on lights with small spacing is arranged on the zero-order light path of the acousto-optic modulator 8. A third garbage pool 10 for receiving the reflected light is arranged on the reflected light path of the D-shaped reflector 9, for collecting the zero-order light.

An optical isolator 2 is arranged between the laser transmitter and the first half-wave plate 3 to prevent reflection of the light running along the light path due to external reasons and improve the production effect of the one-dimensional optical lattice.

The reflection unit includes a third polarizing beam splitter 21, a third half-wave plate 23 and a fourth reflector 24. The receiving end of the third polarizing beam splitter 21 is arranged corresponding to the light outlet, and the third polarizing beam splitter 21 functions to: allow the dipole light loaded with BEC (in the prior art, the optical dipole trap formed by the first dipole light 29 and the second dipole light 30 is a key step in preparing BEC) transmit therethrough, and the third half-wave plate 23 is arranged on the reflected light path of the third polarizing beam splitter 21, the fourth reflector 24 is arranged on a side of the third half-wave plate 23 away from the third polarizing beam splitter 21, and the combination of the third polarizing beam splitter 21 and the third half-wave plate 23 can also adjust the polarization and light intensity of the transmitting light of the fourth reflector 24.

The transmission light path of the third polarizing beam splitter 21 is provided thereon with a fourth garbage pool 22 for receiving the transmission light.

The laser 1 can adopt a semiconductor laser 1 with a wavelength of 1064 nm, or other types of lasers 1 which meets the requirements for producing one-dimensional optical lattice.

In order to facilitate the operator to preliminarily observe whether the incident light coincides with the reflected light, the scientific chamber 20 is provided with a window for observation.

A production method for the one-dimensional optical lattice production device with calibration function includes the following steps.

In step 1, a magneto-optical trap is loaded in the scientific chamber 20 with a vacuum degree of 2.1×10⁻⁹ Pa, an ultra-cold sodium atom sample is obtained in the magneto-optical trap, and the ultra-cold sodium atom sample is further cooled by a method of compressing the magneto-optical trap and optical molasses; and finally the atom sample is loaded into the optical dipole trap to form sodium BEC in the scientific chamber 20 by evaporative cooling.

In step S2, the laser beam passes through the optical isolator 2, through the first half-wave plate 3 to the first polarizing beam splitter 4, so as to be split into a transmitted beam which enters a center of the first garbage pool 5 and a reflected beam which passes through a center of the first lens group 6, and then is reflected by the first reflector 7 into the acousto-optic modulator 8. The zero-order light from the acousto-optic modulator 8 enters a center of the third garbage pool 10 through the D-shaped reflector, and the +1 order light from the acousto-optic modulator 8 passes through the second lens group 11, the third reflector 13 and the fourth reflector 24 to enter the optical fiber coupler 14. Then, the +1 order light is transmitted through the optical fiber 15 and emitted from the collimator 16, and subsequently passes through the second polarizing beam splitter 18 to be split into a transmitted beam which enters the center of the scientific chamber 20 and a reflected beam which enters the second garbage pool 19. The laser emitted from the light outlet of the scientific chamber 20, passes through the third polarizing beam splitter 21, and is split into a transmitted light beam entering the fourth garbage pool 22 and a reflected light beam passing through the third half-wave plate 23 to reach the fourth reflector 24;

In step S3, the fourth reflector 24 is adjusted so that the reflected light and the incident light roughly coincide, and the fourth reflector 24 and the collimator 16 are adjusted by observing the light spot on the window of the scientific chamber 20, so that the light spots on both sides roughly coincide.

In step S4, the light path coincidence calibration unit is installed, the fourth half-wave plate 26 and the fifth half-wave plate 27 are adjusted so that the incident laser light can pass through the fourth polarization beam splitter prism 25 and the fifth half-wave plate 27 normally while the reflected light is reflected through the fourth polarizing beam splitter 25. At this time, the optical power probe 28 is capable of receiving the reflected light and obtaining the intensity of the reflected light. The fourth reflector 24 is continuously adjusted upon observation of the optical power change of the optical power probe 28, until the light intensity is the strongest, then the light path coincidence calibration unit is removed, and the calibration is completed;

In step S5, the one-dimensional optical lattice is produced.

Adaptive changes made according to actual needs are all within the protection scope of the present disclosure.

It should be noted that it is obvious to those skilled in the art that the present disclosure is not limited to the details of the above-mentioned exemplary embodiments, and the present disclosure can be implemented in other specific forms without departing from the spirit or essential characteristics of the present invention. Therefore, the embodiments are to be regarded in all respects as illustrative and not restrictive, and the scope of the disclosure is to be defined by the appended claims rather than the foregoing description, all changes within the meaning and scope of the equivalents of the claims would be included within the present disclosure. Any reference signs in the claims shall not be construed as limiting the involved claim.

In the present disclosure, specific examples are used to illustrate the principles and implementations of the present disclosure, and the descriptions of the above embodiments are only used to help understand the method and the core idea of the present disclosure. There will be changes in the specific implementation and application range according to the idea of the present disclosure. In conclusion, the contents of the specification should not be construed as limiting the present disclosure.

What is claimed is:

1. A one-dimensional optical lattice production device with calibration function, comprising: a laser incident unit, a scientific chamber for forming an optical lattice, a reflection unit for reflecting laser, and a light path coincidence calibration unit detachably arranged, wherein two ends of the scientific chamber are provided with a light inlet and a light outlet respectively, a laser path of the laser incident unit is arranged corresponding to the light inlet, and a reflected laser path of the reflection unit is arranged corresponding to the light outlet; the light path coincidence calibration unit comprises a fourth polarizing beam splitter, a fifth half-wave plate that adjusts a reflected laser such that the reflected laser is reflected on the fourth polarizing beam splitter, a fourth half-wave plate that adjusts incident laser such that the incident laser normally passes through the fourth polarizing beam splitter and the fifth half-wave plate, and an optical power probe; the fourth half-wave plate, the fourth polarizing beam splitter, and the fifth half-wave plate are sequentially arranged on the laser path of the laser incident unit, the optical power probe is arranged on a reflecting path of the fourth polarizing beam splitter.

2. The one-dimensional optical lattice production device with calibration function according to claim 1, wherein the laser incident unit comprises a laser transmitter for emitting laser, and an optical fiber coupler, an optical fiber and a collimator connected in sequence; a receiving end of the optical fiber coupler is arranged corresponds to a laser light path of the laser transmitter, and a transmitting end of the collimator is arranged corresponding to the light inlet.

3. The one-dimensional optical lattice production device with calibration function according to claim 2, wherein a first half-wave plate and a first polarizing beam splitter are arranged on a laser light path between the laser transmitter and the optical fiber coupler; the first half-wave plate is arranged close to the laser transmitter, a second half-wave plate and a second polarizing beam splitter are arranged on a laser light path between the collimator and the light inlet, and the second half-wave plate is arranged close to the collimator.

4. The one-dimensional optical lattice production device with calibration function according to claim 3, wherein a first garbage pool for receiving transmitted light is provided on a transmitted light path of the first polarizing beam splitter, and a second garbage pool for receiving reflected light is arranged on a reflected light path of the second polarizing beam splitter.

5. The one-dimensional optical lattice production device with calibration function according to claim 3, wherein a first lens group, a first reflector, an acousto-optic modulator, a second lens group, a second reflector, and a third reflector are arranged between the first polarizing beam splitter and the optical fiber coupler in sequence, the first lens group is arranged on a reflected light path of the first polarizing beam splitter, and the first reflector reflects transmitted light from the first lens group to the acousto-optic modulator, the second lens group is arranged on a +1 order light path of the acousto-optic modulator, and transmitted light from the second lens group enters the optical fiber coupler after being reflected by the second reflector and the third reflector, and the fourth half-wave plate, the fourth polarizing beam splitter and the fifth half-wave plate are sequentially arranged on a laser path between the second lens group and the second reflector.

6. The one-dimensional optical lattice production device with calibration function according to claim 5, wherein a D-shaped reflector is arranged on a zero-order light path of the acousto-optic modulator, and a third garbage pool for receiving reflected light is arranged on a reflected light path of the D-shaped reflector.

7. The one-dimensional optical lattice production device with calibration function according to claim 3, wherein an optical isolator is arranged between the laser transmitter and the first half-wave plate.

8. The one-dimensional optical lattice production device with calibration function according to claim 1, wherein the reflection unit comprises a third polarizing beam splitter, a third half-wave plate and a fourth reflector, a receiving end of the third polarizing beam splitter is arranged corresponding to the light outlet, and the third half-wave plate is arranged on a reflected light path of the third polarizing beam splitter.

9. The one-dimensional optical lattice production device with calibration function according to claim 8, wherein a fourth garbage pool for receiving transmitted light is arranged on a transmitted light path of the third polarizing beam splitter.

10. A production method for a one-dimensional optical lattice production device with calibration function, comprising following steps:
loading step, configured for loading a magneto-optical trap in a scientific chamber with a vacuum degree of 2.1×10−9 Pa, obtaining an ultra-cold sodium atomic sample in the magneto-optical trap, cooling the ultra-cold sodium atomic sample by compressing the magneto-optical trap and optical molasses, and loading the atomic sample into the optical dipole trap to form sodium BEC in the scientific chamber by evaporative cooling;
propagating step, configured for passing a laser beam through an optical isolator, through a first half-wave plate to a first polarizing beam splitter, entering a transmitted beam of the laser beam into a center of a first garbage pool, passing a reflected beam of the laser beam through a center of a first lens group and into an acousto-optic modulator after being reflected by a first reflector, guiding zero-order light of the acousto-optic modulator into a center of a third garbage pool through a D-shaped reflector, and passing +1 order light of the acousto-optic modulator into an optical fiber coupler through a second lens group, a third reflector, and a fourth reflector; transmitting the laser light through optical fiber, out of a collimator, and into a second polarizing beam splitter; guiding a reflected beam therefrom into a second garbage pool, passing a transmitted beam from the second polarizing beam splitter through a center of the scientific chamber, through a third polarizing beam splitter, and guiding a transmitted beam from the third polarizing beam splitter into a fourth garbage pool and passing the reflected beam therefrom through a third half-wave plate and into a fourth reflector;
adjusting step, configured for adjusting the fourth reflector such that reflected light and incident light roughly coincide, and adjusting the fourth reflector and the collimator upon observing light spots on windows at both sides of the scientific chamber such that the light spots at both sides roughly coincide;
calibrating step, configured for installing a light path coincidence calibration unit, adjusting a fourth half-wave plate and a fifth half-wave plate such that incident light and reflected light enter an optical power probe after being reflected by a fourth polarizing beam splitter, continuously adjusting a fourth reflector upon observing intensity changes of optical power of the optical power probe, removing the light path coincidence calibration unit when a light intensity reach a maximum, thereby completing calibration; and
producing step, configured for producing the one-dimensional optical lattice.
